(19) United States
(12) Patent Application Publication
(10) Pub. No.: US 2010/0159417 A1
(43) Pub. Date: Jun. 24, 2010

(54) DENTAL IMPRESSION CAP WITH ENGAGEMENT FEATURE

(76) Inventor: Dale Whipple, East Taunton, MA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/337,896

(22) Filed: Dec. 18, 2008

(51) Int. Cl. A61C 8/00

(52) U.S. Cl. 433/172

(57) ABSTRACT

A dental coping includes a partially circumferential rib or other engagement feature formed on the coronal portion of the interior surface of the coping that removably engages a groove formed in the corresponding surface of an abutment, implant, analog or other component and enables tactile verification (such as a snap feel) that the coping is properly positioned on the component. The engagement feature may include one or more tapered surfaces. The coping is optionally provided with an interior alignment surface that corresponds to an alignment surface formed on the exterior surface of the dental component, as well as having an optional external alignment feature that enables external visual and tactile assistance in aligning the internal alignment surfaces of the coping and component. The coping also may include one or more chamfered or cylindrical surfaces to provide a precision fit of the coping on the component.

### FIELD OF THE INVENTION

The present invention relates generally to the field of dental components, and more specifically to components used during the process of taking an impression of a patient's mouth to record accurately the position and orientation of an implant site to enable accurate fabrication of restorative components. The inventive components include an impression cap for use in a pick-up impressioning method and abutments, implants, analogs and other dental components that are designed to removably engage the impression cap.

### BACKGROUND OF THE INVENTION

Dental implants are widely used to replace lost or damaged natural teeth. The insertion of an implant may be accomplished in several stages. First, an implant is positioned in the maxillary or mandibular bone of the patient and allowed to heal for a period of time, during which osseointegration of the implant into the bone occurs. A healing cap may be positioned over the implant during this time. After the healing period of time, the healing cap is removed and an abutment is coupled to the implant. Once the abutment is secured, an impression may be taken to accurately record the position and orientation of the implant site and to provide the information needed to fabricate the restorative components.

One method of taking an impression of an implant site involves the use of an impression or transfer cap. The impression cap is placed on the abutment or implant. Impression material is applied to the site such that the impression material is squeezed around the impression cap and into the implant site and then removed from the patient's mouth. The impression cap remains in the impression material when it is removed, and it is therefore advantageous for the impression cap to engage removably the abutment or implant during the impression-making process. The impression material is used to create a mold of the implant site for use in fabricating the desired replacement components.

### SUMMARY OF THE INVENTION

The present invention relates to an impression cap or other dental coping for removably engaging with a dental component such as an abutment, implant and/or and analog. The impression cap or other coping is designed with an engagement feature, an external alignment feature, and an interior alignment feature to provide a precision fit of the cap onto the dental component. Additionally, the impression cap or other coping is designed so as not to extend below the gingival margin, making the outside surface compact and minimizing or eliminating interference with the soft tissue around the implant.

More specifically, the present invention relates to an impression cap or other coping including a partially circumferential rib or other engagement feature formed on the coronal portion of the interior surface of the cap that removably engages a groove formed in the corresponding surface of an abutment, implant, analog or other component and enables tactile verification that the cap is properly positioned on the component. The cap is optionally provided with an interior alignment surface that corresponds to an alignment surface formed on the exterior surface of the dental component, as well as having an optional external alignment feature that enables external visual and tactile assistance in aligning the internal alignment surfaces of the cap and component. The cap may also include one or more chamfered and/or cylindrical surfaces to assist in providing a precision fit of the cap on the component.

A dental coping in accordance with the present invention may include: a body having a frusto-conical exterior surface, an interior recess, a closed coronal end and an open apical end; a frusto-conical inner surface provided in the interior recess; and an engagement feature formed as a protrusion on the inner surface and extending at least partially circumferentially around the interior recess, wherein the engagement feature is positioned closer to the coronal end of the interior recess than to the apical end of the interior recess. The dental coping may also include a coronal tapered surface and an apical tapered surface, wherein the coronal and apical tapered surfaces respectively form the coronal and apical edges of the engagement feature. The coronal and apical tapered surfaces may have taper angles designed to achieve a snap fit of the engagement feature with the dental component.

Additionally, a cylindrical engaging surface optionally may be provided on the inner surface at the open apical end, wherein the cylindrical engaging surface engages a cylindrical surface portion of the dental component extending from the gingival tissue. One or more chamfered surfaces optionally may be provided on the inner surface coronally adjacent to the cylindrical engaging surface, wherein the chamfered surfaces are sloped at various angles with reference to a longitudinal axis of the coping and provided to accommodate corresponding beveled surface portions of the dental component coronally adjacent to the cylindrical surface portion. The coping may further include a coronally extending alignment structure positioned on the closed coronal end and/or a flat aligning surface extending longitudinally on the inner surface. If both are provided, the flat aligning surface may be aligned with the coronally extending alignment structure.

A dental assembly for use with the dental coping may include a dental component comprising a groove for engaging the engagement feature in the interior recess of the coping to enable removable engagement of the impression cap with the dental component. The groove or engagement feature of the dental component may also include a coronal tapered surface and an apical tapered surface that correspond to the coronal and apical tapered surfaces of the engagement feature on the coping.

If alignment features are provided on the coping as described above, the dental component may also include a flat outer surface portion that aligns with the flat aligning surface and the coronally extending alignment structure of the coping. The dental components may further include cylindrical and/or chamfered surfaces that correspond with the optional cylindrical and/or chamfered surfaces of the coping.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1 illustrates a cross-sectional view of an impression cap, abutment and implant in accordance with the present invention.

FIG. 2 depicts a rotated view of the cross-sectional view of the impression cap, abutment and implant of FIG. 1.

FIG. 3 illustrates a radial cross-section of the impression cap taken along the line A-A in FIG. 2.

FIG. 4 provides a detailed illustration of the engagement feature of the impression cap and corresponding groove formed in the abutment of FIGS. 1 and 2.

FIG. 5 illustrates a radial cross-section of the impression cap taken along the line B-B in FIG. 2.

FIGS. 6 and 7 illustrate external views of the impression cap of FIGS. 1 and 2.

FIG. 8 provides a three-dimensional perspective of the impression cap of FIGS. 1 and 2.

FIG. 9 illustrates a cross-sectional view of an exemplary abutment that may be utilized with the impression cap of FIGS. 1-8.

FIG. 10 depicts a rotated view of the cross-sectional view of the abutment of FIG. 9.

FIG. 11 provides a detailed illustration of the groove formed in the abutment of FIGS. 9 and 10.

FIG. 12 illustrates a top view of the abutment of FIGS. 9-1 1.

FIG. 13 illustrates three exemplary abutments for use with the impression cap of FIGS. 1-8.

FIG. 14 illustrates an exemplary implant/abutment assembly for use with the impression cap of FIGS. 1-8.

FIGS. 15 and 16 illustrate the features of an alternative impression cap, abutment, and implant in accordance with the present invention.

FIG. 17 illustrates the use of the impression cap of FIGS. 15 and 16 with an analog.

### DESCRIPTION OF THE PREFERRED EMBODIMENT AND METHOD

The present invention will now be described with reference to the accompanying drawings. The accompanying drawings are intended to provide examples of implementations of the present invention, but are not intended to limit the application of the inventive concepts to the illustrated structures. The inventive engagement and alignment features described herein may be implemented in a variety of dental copings and dental components as would be apparent to one of skill in the art.

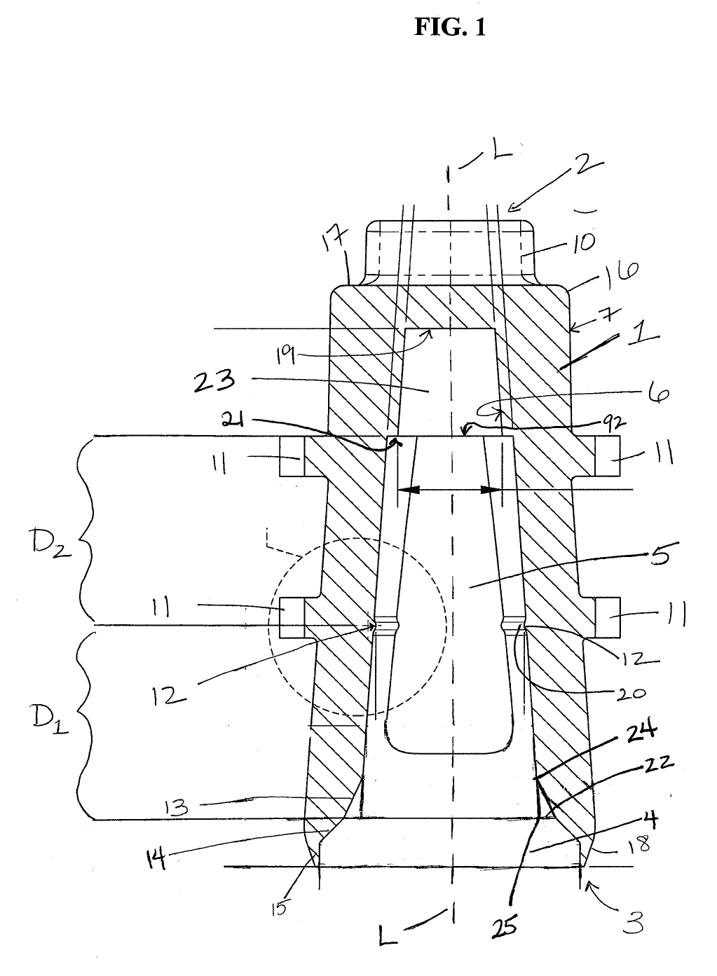

With reference to the accompanying drawings, FIG. 1 depicts an impression cap 1 having a coronal end 2, an apical end 3, and a longitudinal axis L. The impression cap 1 is positioned on an abutment 5 coupled to an implant 4.

The impression cap 1 forms an interior recess with a frusto-conical inner surface 6 that is closed at surface 19 at the coronal end 2 of the cap 1 and open at the apical end 3 of the cap 1. The inner surface 6 of the interior recess of cap 1 is generally frusto-conical in shape, tapering inwardly from the apical end 3 to the coronal end 2 of the cap 1.

The outer surface 7 of the impression cap 1 may be generally frusto-conical in shape, tapering inwardly from the apical end 3 toward the coronal end 2 of the cap 1. Several structures may be provided on the exterior surface of the cap 1, for example, to assist in positioning of the cap 1 on the abutment 5 and/or to facilitate the embedding of the cap 1 in the impression material. Specifically, cap 1 includes a coronally extending alignment structure 10 that extends from the substantially flat top surface 17 of the cap 1 to assist with alignment of the cap 1 on the abutment 5. Additionally or alternatively, one or more protrusions, such as circumferential protrusions 11, that extend radially from the outer surface of the cap 1 may be provided. The coronal end 2 of the cap 1 may also have a shoulder portion 16. An inwardly tapering portion 18 may be provided at the apical base of the cap where the cap 1 surrounds the implant 5.

The inner surface 6 of the impression cap 1 is provided with an engagement feature 12 comprising a circumferential or partially circumferential rib or other protrusion that extends from the inner surface 6 toward the longitudinal axis L of the cap 1. The engagement feature 12 is positioned to engage a corresponding partially circumferential recess 20 formed in the surface of abutment 5. Engagement feature 12 is positioned such that the distance D1 between the coronal surface 22 of the implant 4 (where abutment 5 emerges from implant 4) and the engagement feature 12 is greater than the distance D2 between the engagement feature 12 and the coronal surface 92 of abutment 5.

Near the apical end 3 of the cap 1, the inner surface 6 of the cap 1 may further include one or more chamfered surfaces, such as surfaces 13 and 14, as well as one or more longitudinally extending engaging surfaces, such as surface 15.

In the embodiment of FIG. 1, surface 13 is chamfered away from the surface of abutment 5 to create a space or gap between the inner surface 6 of cap 1 and the outer surface of abutment 5. This space or gap extends from upper point 24 to lower point 25 as shown in FIG. 1. Coronal surface 22 of implant 4 is contained within this space. Chamfered surface 13 is provided to facilitate insertion of the cap 1 onto the abutment 5 and implant 4 by accommodating the coronal surface 22 of the implant 4 that extends beyond the outer surface of the abutment 5 in a radial direction.

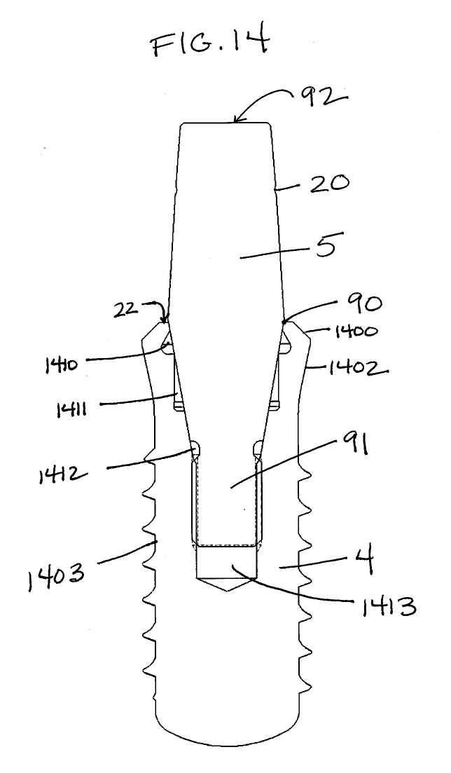

Engaging surface 14 corresponds to outwardly tapering frusto-conical surface 1400 surface of abutment 5 (see FIG. 14). Surface 15 corresponds to longitudinally extending cylindrical surface 1401 of the implant 4 as shown in FIG. 14. Additional and/or alternative chamfered and/or longitudinal surfaces may be provided on the inner surface 6 of the cap 1 as may be desired for precision fit of the cap 1 onto the implant 4, abutment 5, or other component.

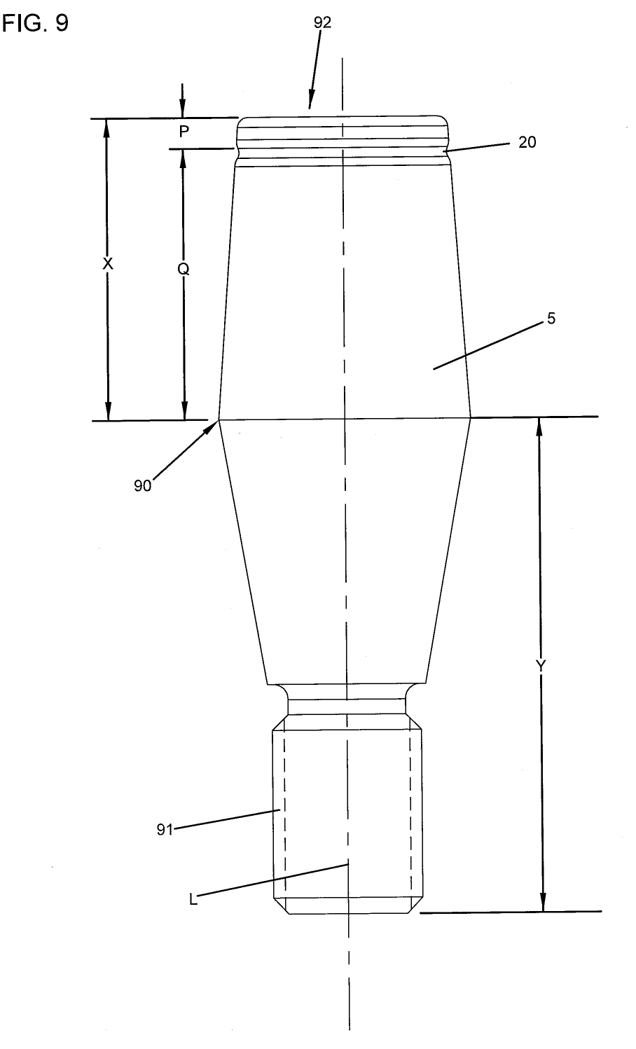

A hollow space 23 may be created within the interior of the cap 1 between the coronal end 92 of the abutment 5 (see FIGS. 9-11) and the coronal inner surface 19 of the cap 1. A surface portion 21 of the inner surface 6 may abut an outer circumferential portion of the top surface 92 of the abutment 5.

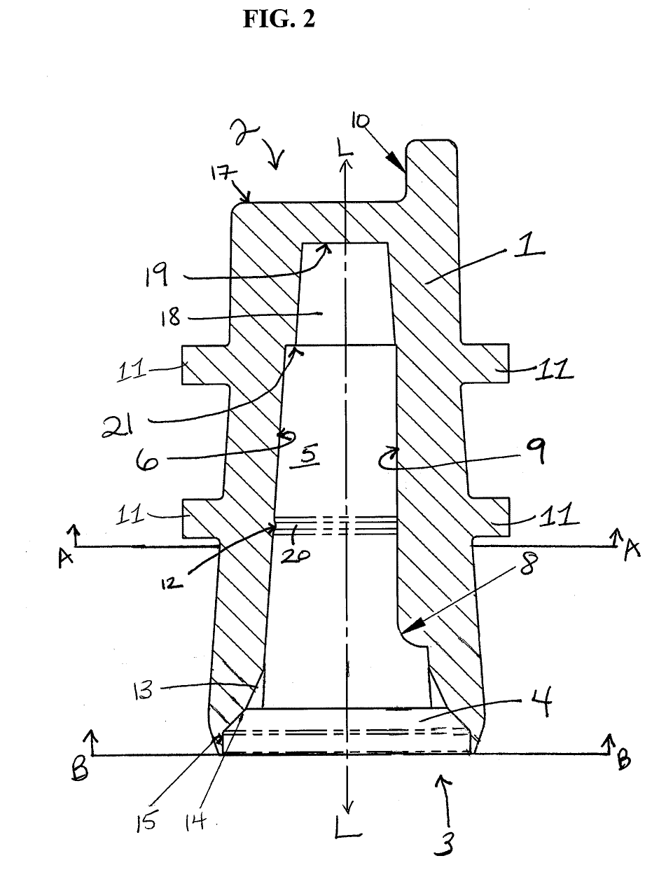

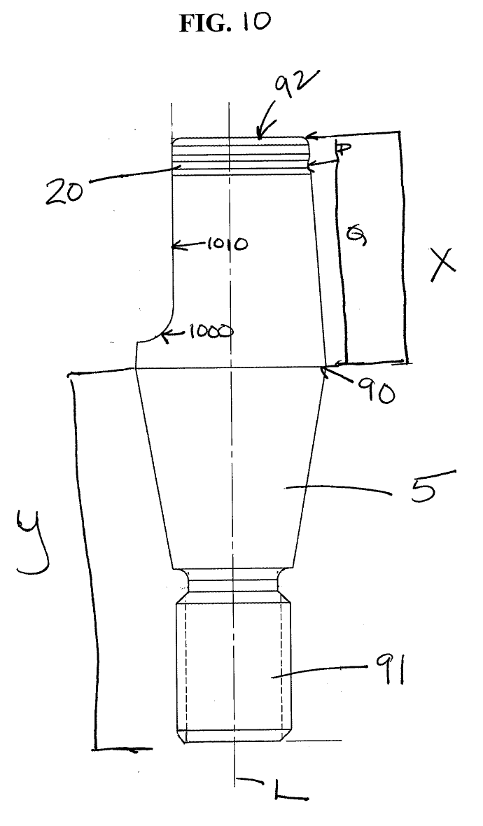

FIG. 2 provides an illustration of the impression cap 1, abutment 4 and implant 5 of FIG. 1 that have been rotated 90 degrees about the longitudinal axis L of the cap 1. An alignment feature is provided on the inner surface 6 of the cap 1. Specifically, a substantially flat inner surface portion 9 is provided that extends longitudinally and substantially parallel to the longitudinal axis L of the cap 1. Surface portion 9 is aligned with extending portion 10 on the coronal end 2 of the cap 1 to assist in alignment of the cap 1 on the abutment 5. At the apical end of surface portion 9, a curved surface portion 8 is provided to correspond to the inner surface geometry of abutment 5 (described below with reference to FIG. 10).

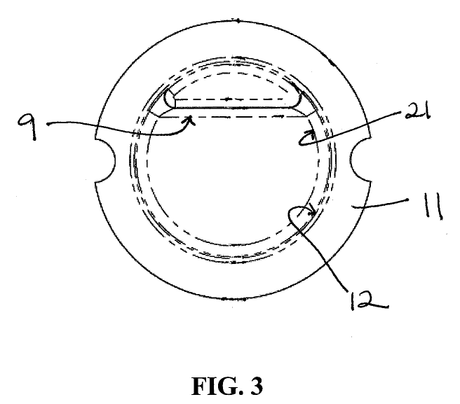

FIG. 3 provides a cross-sectional view of the impression cap of FIG. 2 along line A-A. The cross-sectional view illustrates the circumferential protrusions 11, the engagement feature 12, the surface portion 21 that abuts the top of the abutment 5, and the alignment surface portion 9.

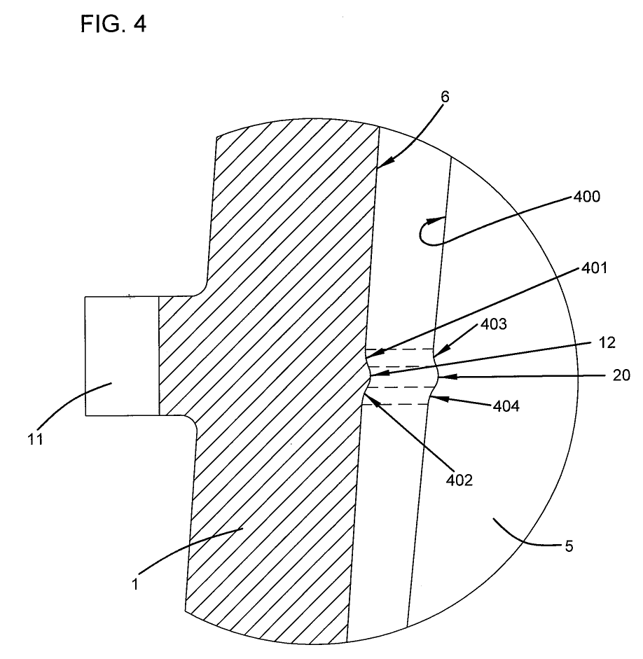

FIG. 4 provides a detailed drawing of the engagement feature 12 formed on the inner surface 6 of the impression cap 1 and its alignment with groove 20 formed in the surface 400 of abutment 5.

The engagement feature 12 may be designed to enable tactile verification that the impression cap 1 has been properly positioned on the abutment 5 (or other dental component). Tactile verification of correct positioning of the cap 1 may be provided as a snap feel, such that the engagement feature 12 snaps into the recess 20. To achieve such a snap feel when engagement feature 12 engages recess 20, the engagement feature 12 builds up potential energy prior to snapping into engagement with recess 20. Engagement feature 12 then releases this energy in a rapid motion as it enters recess 20. Recess 20 then stops solidly the motion of engagement feature 12. This sequence generates the snap feel that enables tactile verification of the correct positioning of the cap 1 on the abutment 5.

The connection of an external cone (here impression cap 1) over an internal cone (here abutment 5) necessitates limiting of the damping effect of the cone-to-cone interface. As the engagement feature 12 on cap 1 stretches up the surface 400 of abutment 5, it builds up potential energy. When the engagement feature 12 reaches the recess 20, it rapidly relaxes into the recess 20. This rapid relaxation causes the cap 1 to move rapidly in the apical direction onto abutment 5. When the engagement feature 12 encounters the apical side of recess 20, it stops suddenly. This sudden stop provides the snap feel, which is generated by the inertia of inner surface 6 of cap 1 slamming into outer surface 400 of abutment 5 and coming to a solid stop (in essence, causing a micro-crash), resulting in noise and shock. To ensure that this sequence of interactions can occur to generate the desired snap feel (i.e., cap 1 moves rapidly and then stops suddenly when engagement feature 12 engages recess 20), clearance is provided between the frusto-conical surface of abutment 5 and inner surface 6 of cap 1 to prevent unwanted damping of the shock. To accomplish this clearance and yet maintain a proper fit between cap 1 and abutment 5, the frusto-conical surface of abutment 5 is tapered a little on both sides (coronal and apical) of recess 20. Cap 1 is provided with tapered surfaces 401 and 402 that respectively form the coronal and apical edges of engagement feature 12. The apical and coronal taper angles of surfaces 403 and 404 of abutment 5 edging recess 20 correspond to the respective taper angles of surfaces 401 and 402 of cap 1. The taper angles of surfaces 401, 402, 403 and 404 may preferably may be in the range of 1-2 degrees with reference to the inner surface 6 of cap 1 or outer surface 400 of abutment 5, although any desired angle may be used. The apical and coronal taper angles may be substantially identical or may be different as needed to generate the desired snap feel.

In the illustrated embodiment, the engagement feature 12 is provided as a partially circumferential rib that is fabricated as an integrated molded portion the impression cap 1. The engagement feature 12 extends around the circumference of the inner surface 6 and does not extend across alignment surface portion 9 of the inner surface 6. The engagement feature 12 is provided at a point on the inner surface 6 of the cap 1 such that distance D1 is greater than distance D2 (see FIG. 1). When the impression cap 1 is fitted over the abutment 5 and pressed in the apical direction 3, the rib engages groove 20 in the abutment 5 and secures the impression cap 1 against the top of the implant 4 at surfaces 14 and 15. Engagement of the rib 12 into groove 20 may produce a tactile verification in the form of a snap that indicates that the impression cap 1 is correctly positioned on the abutment 4 and implant 5.

In alternative embodiments (not shown), the engagement feature 12 may extend around the full circumference of the inner surface 6 of the cap 1, may extend only partially around the circumference, or may be provided as multiple protrusions at various locations as desired to enable removable engagement of the cap 1 with the abutment 5. The engagement feature 12 may also be fabricated from any desired material and may be fabricated as a molded portion of the cap 1 or as a separate component that is subsequently attached to the cap 1.

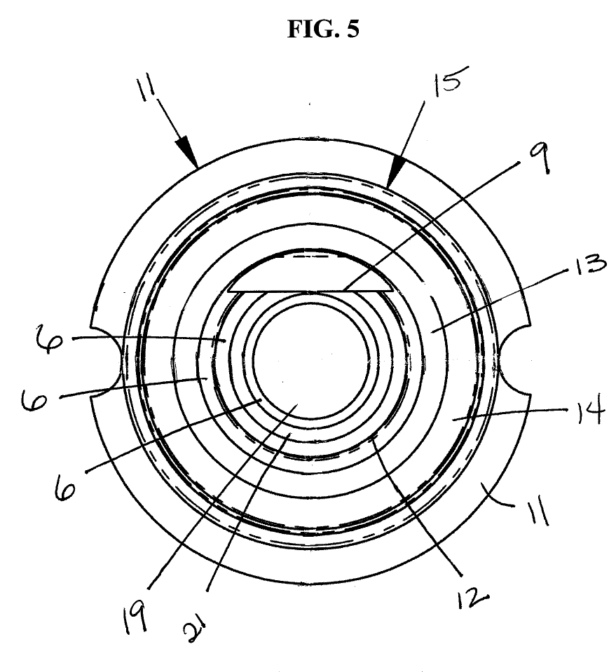

With reference to FIG. 5, a cross-sectional view along the B-B line of FIG. 2 shows inner configuration of the impression cap 1, including coronal inner surface 19, surface portion 21, engagement feature 12, inner surface 6, alignment surface portion 9, surfaces 13, 15 and 14, and external protrusions 11.

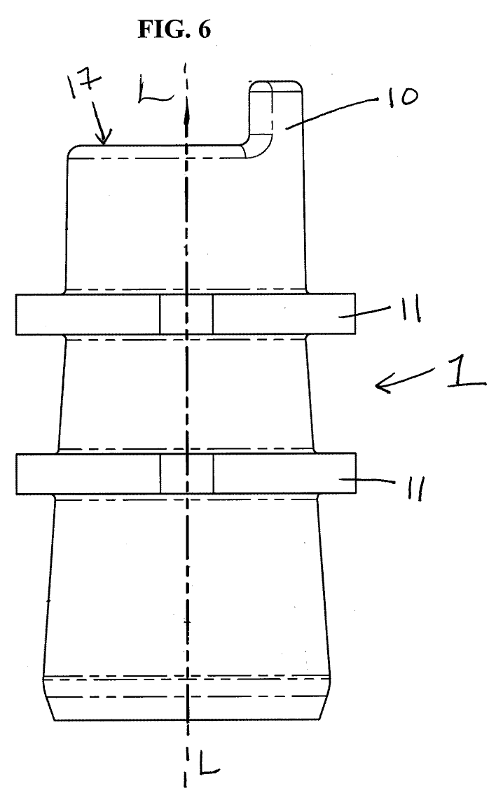

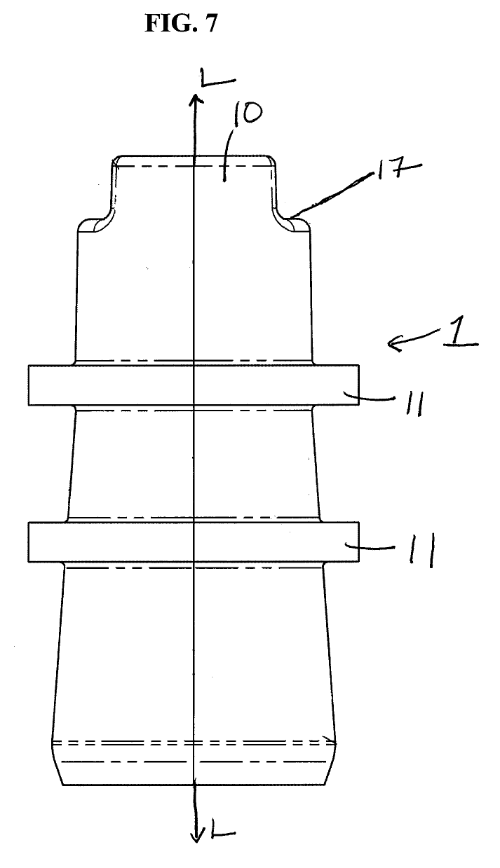

FIGS. 6 and 7 illustrate external views of the impression cap 1, including longitudinally extending portion 10, top surface 17, and protrusions 11.

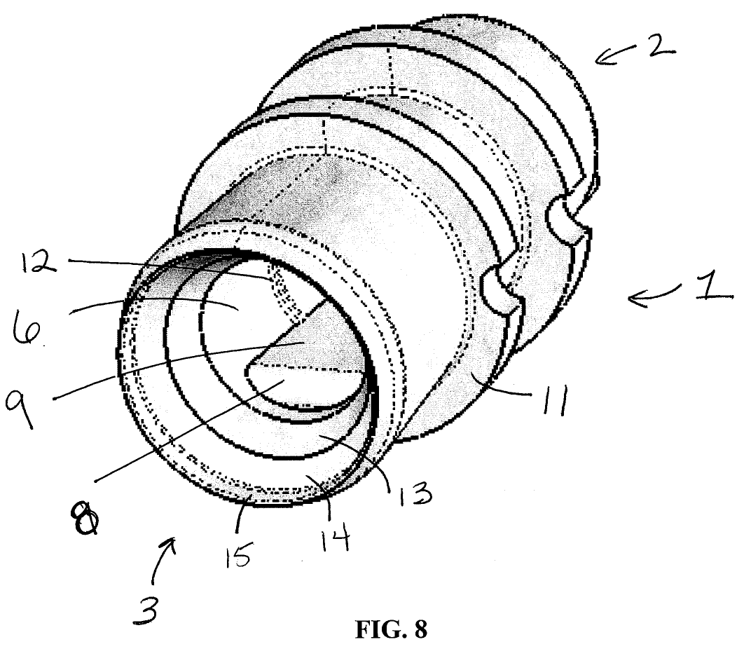

FIG. 8 provides a three-dimensional perspective of the impression cap 1, including surfaces 13, 14, and 15, inner surface 6, engagement feature 12, alignment surface portion 9, and curved surface portion 8.

Impression cap 1 may be manufactured using conventional molding or other fabrication methods using acetal or any other desired material(s).

It is envisioned that healing caps, burnout copings, and other types of dental copings may be provided with an engagement feature such as feature 12 described herein to enable removable engagement of the caps with temporary or permanent abutments, analogs or replicas, and/or other dental components.

FIG. 9 illustrates an abutment that may be utilized with the impression cap 1 described above. Abutment 5 includes means for coupling the abutment 5 to an implant 4 (for example, as shown in FIGS. 1 and 2). For example, abutment 5 may be provided with screw threads that are screwed into a threaded receiving bore in implant 4. Alternative coupling mechanisms also may be utilized.

In FIG. 9, portion Y of abutment 5 includes a threaded portion 91 for engagement with screw threads provided in an inner bore of implant 4 (not shown) and a generally frustoconical portion extending apically from point 90 toward threaded portion 91 and tapering inwardly toward longitudinal axis L. Portion Y is inserted into implant 4. Portion X of abutment 5 is a generally frustoconical portion extending coronally from point 90 and tapering inwardly toward longitudinal axis L to the coronal end 92 of the abutment 5. When portion Y is inserted into implant 4, portion X extends out of the implant 4 in the coronal direction.

In this embodiment of the present invention, a partially circumferential groove 20 is formed in the surface of the abutment 5 at a position above the midpoint of portion X of the abutment 5. Groove 20 extends around the circumference of abutment 5 and does not extend across the flat alignment surface portion 1010 of the abutment's outer surface. The configuration of groove 20 is designed to accommodate the engagement feature 12 of impression cap 1. The position of groove 20 is such that distance P (from the coronal end of the abutment to groove 20) is less than distance Q (from groove 20 to point 90 where the coronal end of the implant 4 is positioned when the abutment 5 is inserted into the implant 4). Groove 20 is formed to engage with engagement feature 12 on the impression cap 1 as described above to enable removable engagement of the cap 1 with the abutment 5 and implant 4.

FIG. 10 provides an illustration of the abutment 5 of FIG. 9 that has been rotated 90 degrees about the longitudinal axis L of the abutment 5. FIG. 10 illustrates the flat alignment surface portion 1010 and curved surface portion 1000 that are formed on abutment 5 to facilitate alignment of the abutment 5 and impression cap 1 by aligning the flat surface 1010 of the abutment 5 with flat alignment surface portion 9 of the cap 1 and curved surface portion 1000 of the abutment 5 with curved surface portion 8 of the cap 1 (as illustrated in FIG. 2).

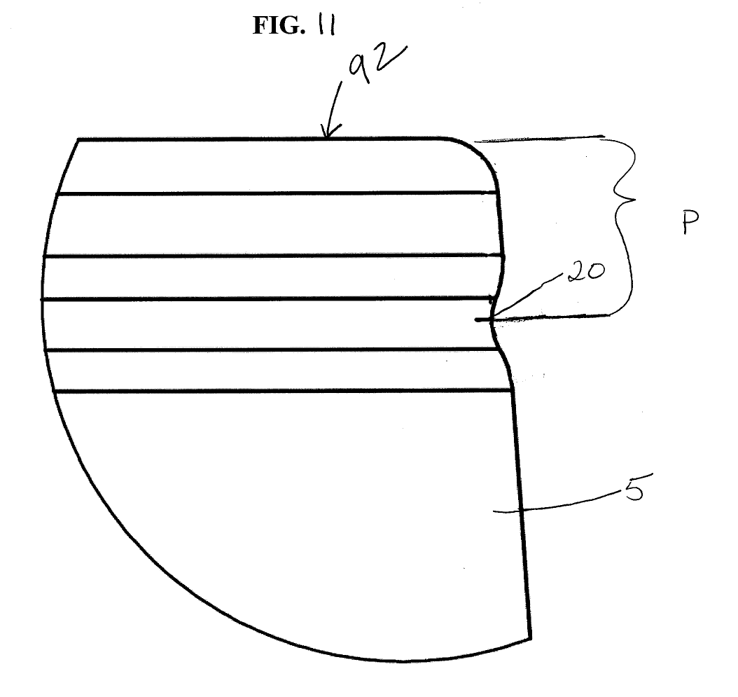

FIG. 11 provides a detailed illustration of groove 20 formed in the surface of abutment 5.

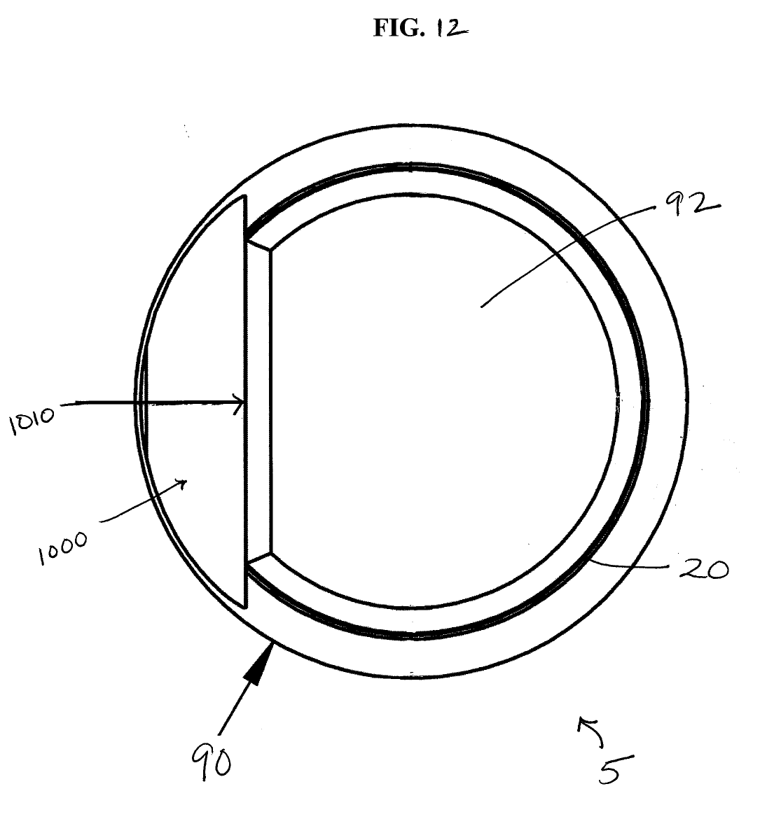

FIG. 12 provides an illustration of a coronal view of abutment 5, including coronal end 92, groove 20, point 90, flat surface portion 1010 and curved surface portion 1000 of abutment 5.

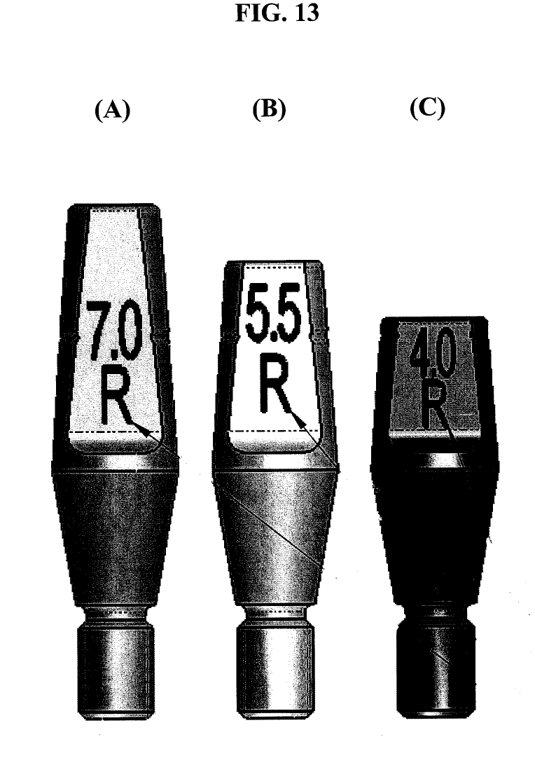

FIG. 13 illustrates three exemplary geometries for abutment 5, all of which are designed to engage with impression cap 1. FIG. 13(A) depicts an abutment 5 having an X portion with a length of 7.0 mm. FIG. 13(b) depicts an abutment 5 having an X portion with a length of 5.5 mm. FIG. 13(C) depicts an abutment 5 having an X portion with a length of 4.0 mm. Alternative abutment lengths may be utilized as desired.

In each of the three embodiments illustrated in FIG. 13, groove 20 is positioned above the midpoint of portion X of the abutment to engage engagement feature 12 of impression cap 1 as described above with reference to FIGS. 1 and 2.

FIG. 14 illustrates an exemplary assembly of an implant 4 and abutment 5 that may be utilized with impression cap 1. Abutment 5 extends coronally from the implant 4 from point 90 to coronal surface 92 of abutment 5. The coronal surface 22 of implant 4 is also depicted. Additionally, implant 4 includes an outwardly tapering outer surface portion 1400 extending apically from the outer edge of coronal surface 22, a cylindrical surface portion 1401 having a surface substantially parallel to the longitudinal axis of the implant 4 and extending apically from surface 1400, and an inwardly tapering portion 1402 extending apically from cylindrical surface portion 1401. A threaded portion 1403 is provided on the external surface of implant 4, and an internal bore is provided within implant 4 to receive abutment 5 as illustrated in FIG. 14. One or more spaces, such as 1410, 1411, 1412, and 1413, may be created by the assembly of implant 4 and abutment 5.

Abutment 5 and implant 4 may be manufactured using a titanium alloy or other material as desired using conventional manufacturing techniques.

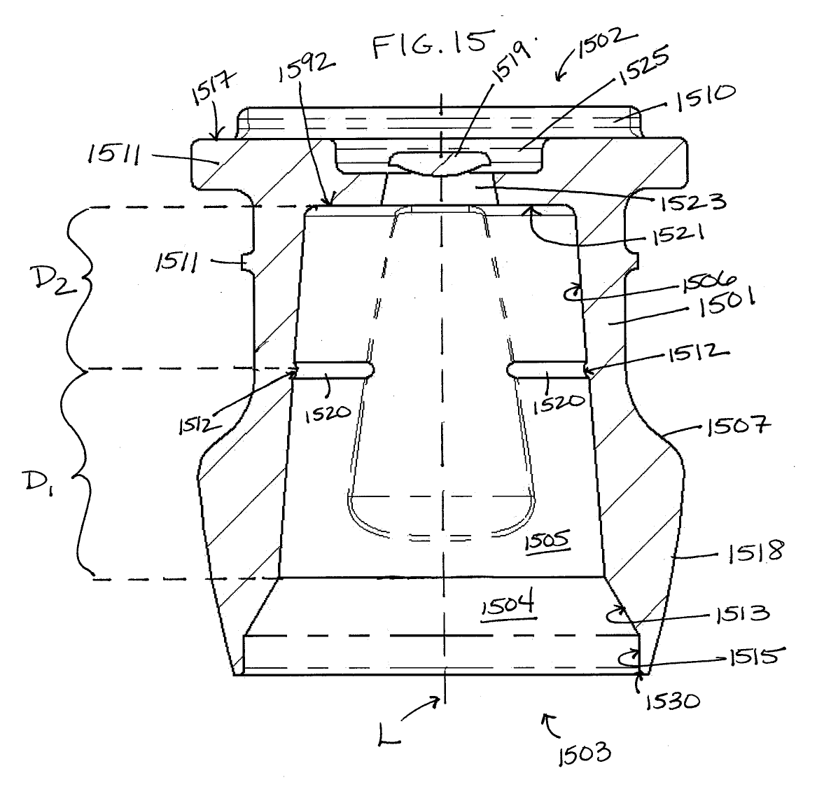

FIGS. 15-17 illustrate an alternative embodiment of an impression cap and dental components for use with the impression cap in accordance with the present invention. FIG. 15 depicts an impression cap 1501 having a coronal end 1502, an apical end 1503, and a longitudinal axis L. The impression cap 1501 is positioned on an abutment 1505 that may be coupled to an implant 1504.

The impression cap 1501 forms an interior recess with a frusto-conical inner surface 1506 that is closed at the coronal end 1502 of the cap 1501 and open at the apical end 1503 of the cap 1501. The inner surface 1506 of the interior recess of cap 1501 is generally frusto-conical in shape, tapering inwardly from the apical end 1503 to the coronal end 1502 of the cap 1501.

The outer surface 1507 of the impression cap 1501 may be contoured in shape as illustrated in FIGS. 15-17. Several structures may be provided on the exterior surface of the cap 1501, for example, to assist in positioning of the cap 1501 on the abutment 1505 and/or to facilitate the embedding of the cap 1501 in the impression material. Specifically, cap 1501 includes a coronally extending alignment structure 1510 that extends from the substantially flat top surface 1517 of the cap 1501 to assist with alignment of the cap 1501 on the abutment 1505. Additionally or alternatively, one or more protrusions of varying designs and dimensions, such as circumferential protrusions 1511, that extend radially from the outer surface and/or coronal surface of the cap 1501 may be provided. An inwardly tapering portion 1518 of surface 1507 may be provided toward the apical end of the cap 1501.

As with the impression cap described above with reference to FIGS. 1-14, the inner surface 1506 of the impression cap 1501 is provided with an engagement feature 1512 comprising a circumferential or partially circumferential rib or other protrusion that extends from the inner surface 1506 toward the longitudinal axis L of the cap 1501. The engagement feature 1512 is positioned to engage a corresponding partially circumferential recess 1520 formed in the surface of abutment 1505. Engagement feature 1512 is positioned such that the distance D1 between the coronal surface of the implant 1504 (where abutment 1505 emerges from implant 1504) and the engagement feature 1512 is greater than the distance D2 between the engagement feature 1512 and the coronal surface 1592 of abutment 1505. Engagement feature 1512 may also include tapered coronal and apical surfaces as described above with reference to FIG. 4.

Near the apical end 1503 of the cap 1501, the inner surface 1506 of the cap 1501 may further include one or more chamfered surfaces, such as surface 1513, as well as one or more longitudinally extending substantially cylindrical engaging surfaces, such as surface 1515.

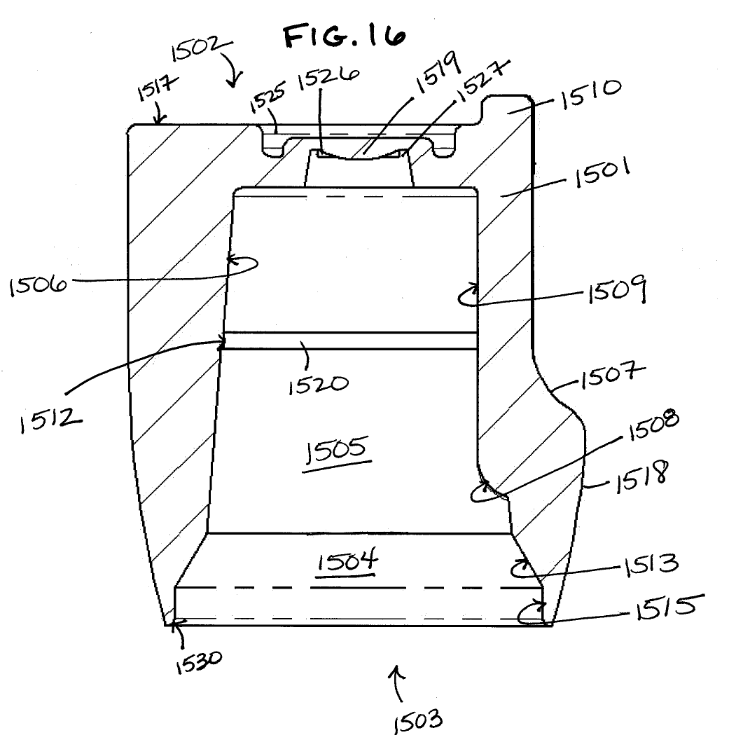

In the embodiment of FIG. 15, surface 1513 is chamfered outwardly to correspond to the sloped surface of implant 1504. Surface 1515 corresponds to a longitudinally extending cylindrical surface of the implant 1504 as shown in FIGS. 15-16. Additional and/or alternative chamfered and/or longitudinal surfaces may be provided on the inner surface 1506 of the cap 1501 as may be desired for precision fit of the cap 1501 onto the implant 1504, abutment 1505, or other component. An additional tapered surface 1530 maybe provided on inner surface 1506 at the apical base of cap 1501, for example, to assist in positioning of the cap 1501 on implant 1504.

An air vent 1523 may be created in the interior of the cap 1501 between the coronal end 1592 of the abutment 1505. The air vent may be accessed by a baffle or flexible cover flap 1519 that is formed to allow air to flow through air vent 1523 while blocking impression material from entering the cap 1501 through the vent. The flexible cover flap 1519 may be positioned in a recess 1525 formed in the coronal surface 1517 of the cap 1501. One or more structures, such as structures 1527, may be provided to position flexible cover flap 1519 in place (see FIG. 16) over air vent 1523. In this illustrated embodiment, structures 1527 are adjacent to spaces 1526. Also, a coronal surface portion 1521 of the inner surface 1506 may abut an outer circumferential portion of the top surface 1592 of the abutment 1505.

FIG. 16 provides an illustration of the impression cap 1501, abutment 1504 and implant 1505 of FIG. 15 that have been rotated 90 degrees about the longitudinal axis L of the cap 1501. An alignment feature is provided on the inner surface 1506 of the cap 1501. Specifically, a substantially flat inner surface portion 1509 is provided that extends longitudinally and substantially parallel to the longitudinal axis L of the cap 1501. Surface portion 1509 is aligned with extending portion 1510 on the coronal end 1502 of the cap 1501 to assist in alignment of the cap 1501 on the abutment 1505. At the apical end of surface portion 1509, a curved surface portion 1508 is provided to correspond to the inner surface geometry of abutment 1505 (similar to that described above for abutment 5 with reference to FIG. 10).

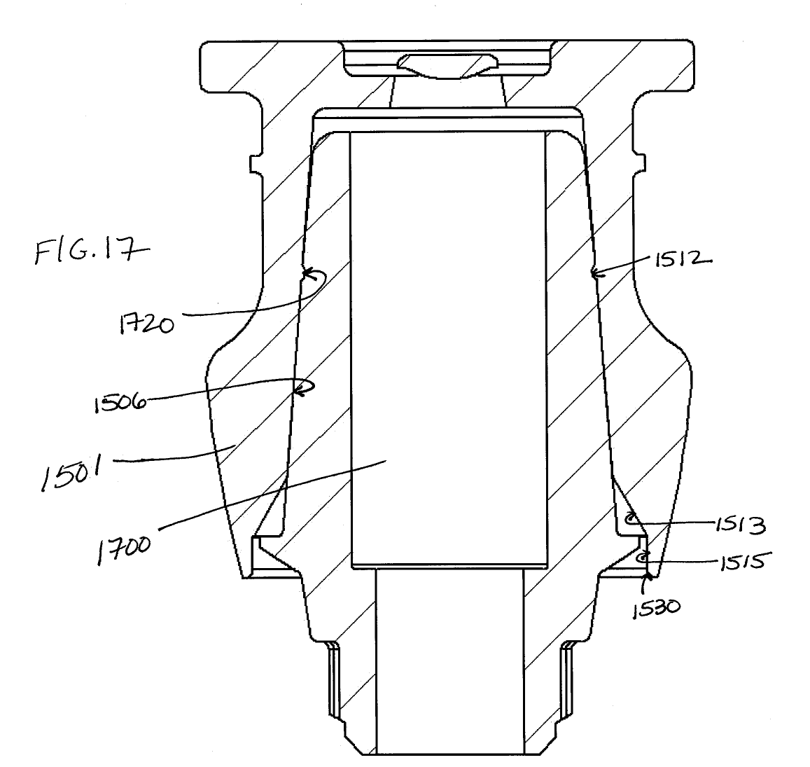

FIG. 17 illustrates the use of impression cap 1501 with an analog 1700. When the cap 1501 is positioned on analog 1700, surfaces 1513, 1515 and 1530 may form gaps between the surface of the analog 1700 and the inner surface 1506 of the cap 1501 as illustrated in FIG. 17. Analog 1700 is provided with a groove or indented surface portion 1720 that receives engagement feature 1512 of cap 1501 to enable engagement of the cap 1501 with the analog 1700.

Impression cap 1501 may be manufactured using conventional molding or other fabrication methods using acetal or any other desired material(s).

It is envisioned that healing caps, burnout copings, and other types of dental copings may be provided with an engagement feature such as feature 1512 described herein to enable removable engagement of the caps with temporary or permanent abutments, analogs or replicas, and/or other dental components.

In alternative embodiments (not shown), various shapes and configurations of engaging features comparable in function to groove or indentation 20, 1520, or 1720 may be provided on abutments such as 5 or 1505, analogs such as 1700, or other dental components. Such engaging features may, for example, extend around the full circumference of the component, may extend only partially around the circumference of the component, or may be provided as multiple grooves, indentations or other engaging features at various locations as desired to enable removable engagement of the cap 1 or 1501 with the component.

Notably, the alignment features described above, including the alignment surfaces 8, 9, 1508 and 1509 and coronally extending alignment surfaces 10 and 1510, are optional and may be omitted without departing from the scope of the present invention. Thus, the impression cap 1 or 1501 may be designed to have a substantially frusto-conical inner surface 6 or 1506 with the engagement feature 12 or 1512.

Additionally, one-piece implants (in which a single component functions as the implant and the abutment), multiple-piece implants, analogs and other dental components may be fabricated with an engagement feature such as groove 20 or 1520 for enabling removable engagement with engagement feature 12 of impression cap 1 (or 1512 of cap 1501) as well as alignment surfaces such as surfaces 1000 and 1010 in accordance with the present invention.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention. Accordingly, it is intended that the scope of the present invention be dictated by the appended claims rather than by the description of the preferred embodiment.

Claimed is:

1. A dental coping for removable engagement with a dental component extending from gingival tissue, comprising:
a body having a frusto-conical exterior surface, an interior recess, a closed coronal end and an open apical end;
a frusto-conical inner surface provided in the interior recess; and
an engagement feature formed as a protrusion on the inner surface and extending at least partially circumferentially around the interior recess, wherein the engagement feature is positioned closer to the coronal end of the interior recess than to the apical end of the interior recess.

2. The dental coping of claim 1, further comprising a coronal tapered surface and an apical tapered surface, wherein the coronal and apical tapered surfaces respectively form coronal and apical edges of the engagement feature.

3. The dental coping of claim 2, wherein the coronal and apical tapered surfaces have taper angles designed to achieve a snap fit of the engagement feature with the dental component.

4. The dental coping of claim 1, further comprising substantially cylindrical engaging surface provided on the inner surface at the open apical end of the dental coping, said cylindrical engaging surface running substantially parallel to a longitudinal axis of the dental coping and provided to accommodate a cylindrical surface portion of the dental component extending from the gingival tissue; and
a first chamfered surface provided on the inner surface coronally adjacent to the cylindrical engaging surface, said first chamfered surface forming a first angle with reference to the longitudinal axis of the dental coping and provided to accommodate a first surface portion of the dental component coronally adjacent to the cylindrical surface portion.

5. The dental coping of claim 1, further comprising a coronally extending alignment structure positioned on the closed coronal end.

6. The dental coping of claim 5, further comprising a flat aligning surface extending longitudinally on the inner surface, wherein the flat aligning surface is aligned with the coronally extending alignment structure.

7. A dental component for use with the coping of claim 1, wherein the dental component includes a groove for engaging the engagement feature in the interior recess of the coping to enable removable engagement of the coping with the dental component.

8. The dental component of claim 7, wherein the groove further comprises a coronal tapered surface and an apical tapered surface that correspond to the coronal and apical tapered surfaces of the engagement feature on the coping.

9. The dental component of claim 7, wherein the component includes an abutment.

10. The dental component of claim 7, wherein the component includes an implant.

11. The dental component of claim 7, wherein the component is an analog.

12. A dental assembly, comprising:
an impression cap for removable engagement with a dental component extending from gingival tissue having:
a body having a frusto-conical exterior surface, an interior recess, a closed coronal end and an open apical end;
a frusto-conical inner surface provided in the interior recess; and
an engagement feature formed as a protrusion on the inner surface and extending at least partially circumferentially around the interior recess, wherein the engagement feature is positioned closer to the coronal end of the interior recess than to the apical end of the interior recess; and
a dental component comprising a groove for engaging the engagement feature in the interior recess of the impression cap to enable removable engagement of the impression cap with the dental component.

13. The dental assembly of claim 12, wherein the impression cap further includes a coronal tapered surface and an apical tapered surface, wherein the coronal and apical tapered surfaces respectively form coronal and apical edges of the engagement feature.

14. The dental assembly of claim 13, wherein the coronal and apical tapered surfaces of the impression cap have taper angles designed to achieve a snap fit of the engagement feature with the groove of the dental component.

15. The dental assembly of claim 12, wherein the impression cap further includes a substantially cylindrical engaging surface provided on the inner surface at the open apical end, said cylindrical engaging surface for engaging a cylindrical surface portion of the dental component extending from the gingival tissue; and
a first chamfered surface provided on the inner surface coronally adjacent to the cylindrical engaging surface, said first beveled engaging surface being sloped at a first angle with reference to a longitudinal axis of the impression cap and provided to accommodate a first surface portion of the dental component coronally adjacent to the cylindrical surface portion.

16. The dental assembly of claim 12, wherein the impression cap further includes a coronally extending alignment structure positioned on the closed coronal end.

17. The dental assembly of claim 12, wherein the impression cap further includes a flat aligning surface extending longitudinally on the inner surface, wherein the flat aligning surface is aligned with the coronally extending alignment structure, and wherein the dental component includes a flat outer surface portion that aligns with the flat aligning surface and the coronally extending alignment structure of the impression cap.

18. The dental assembly of claim 12, wherein the dental component includes an abutment.

19. The dental assembly of claim 12, wherein the dental component includes an implant.

20. The dental assembly of claim 12, wherein the dental component is an analog.
